(19) United States
(12) Patent Application Publication
(10) Pub. No.: US 2008/0256185 A1
(43) Pub. Date: Oct. 16, 2008

(54) SCALABLE WEB HOSTING NETWORK AND METHODS FOR BUILDING AND OPERATING SAME

(75) Inventor: Darius Antia, North York (CA)

Correspondence Address: MCANDREWS HELD & MALLOY, LTD, 500 WEST MADISON STREET, SUITE 3400, CHICAGO, IL, 60661, US

(73) Assignee: NETFIRMS, INC., North York (CA)

(21) Appl. No.: 12/054,836

(22) Filed: Mar. 25, 2008

Related U.S. Application Data
(60) Provisional application No. 60/922,787, filed on Apr. 11, 2007.

(51) Int. Cl. G06F 15/16

(52) U.S. Cl. 709/205

(57) ABSTRACT

The present invention provides a network comprised of a storage and a plurality of servers. Each server is individually in communication with the storage, and each server individually is operating on a pre-selected operating system. There is a plurality of encoded programs provided, with each program individually performing a single pre-selected function, and each program individually being installed and operating on its own server to the exclusion of other single pre-selected function programs. In another preferred embodiment, the present invention provides for the building and maintaining of such a network by providing these elements, and further providing and removing on an ongoing basis additional single pre-selected function programs based on demand, the additional programs being installed and operating on their own server to the exclusion of other single pre-selected function programs. In yet another preferred embodiment, the present invention provides for the operation of such a network.

### RELATED APPLICATIONS

The applicant claims priority based on provisional application No. 60/922,787 filed Apr. 11, 2007, the complete subject matter of which is incorporated herein by reference in its entirety.

### FIELD OF INVENTION

The present invention relates to web hosting through a computer network and more specifically to a non-linear scalable web hosting network and a method for building and operating same.

### BACKGROUND

Remote computer hosting (e.g. web hosting) is a client-server concept that has arisen in commerce largely due to the needs of global computer networks (e.g. Internet™). As a result of global information exchange and electronic commerce (e-commerce), the need for remote computers to host numerous applications, files, and other content or data, and facilitate access thereto, has grown exponentially over the years.

A global computer (“web”) hosting network is typically made up of a storage (such as a computer hard drive or the like) in communication with a plurality of servers. A server is any processor that is capable of receiving, processing, and transmitting a signal, and in the web hosting context, is typically a computer preloaded with a batch or group of single function applications or encoded programs (conventionally, programs for static and/or dynamic content (data) transmission and reception, file transfer protocol (FTP) transmission and reception, mail transmission and reception, and database transmission and reception). The term “single function” means that each of the described programs or applications essentially provide only one function each (for example, a program facilitating static content transmission serves no other appreciable function other than facilitating static content transmission). In web hosting, only certain types of single function programs are desirable or required, namely those programs that specifically facilitate accessing, manipulating, and/or transmitting sought data or content on the network storage, the prevalence of the desired program types being driven by third party user (customer) demand.

In the web hosting context, a server is able to receive a signal (typically in the form of a uniform resource locator (URL)) and is also able to “serve” or transmit to a third party user a signal in the form of a web page or other content specifically requested, the constitution of the transmitted signal being determined at least in part by content on the storage device.

In relation to the third party user, the previously described single function programs are installed on remote servers, and each server is conventionally configured with all of these programs (i.e. each server has an identical batch or group of single function programs installed thereon). These single function programs run over and above background programs or programs performing less important functions (functions not directly related to web hosting but necessary for each server to have at least basic operability (i.e. an operating system)). In other words, these servers have an operating system installed thereon, and additionally a group of web host-based program functions specifically sought by third party users, examples of which include all of static and dynamic content (data) transmission and reception, FTP transmission and reception, mail transmission and reception, and database transmission and reception.

Conventional web host network expansion is difficult and expensive because these conventional networks grow linearly (each server added on in the existing network is identical to the others, with respect to the group of preloaded programs being provided). Linear growth forces a web host to acquire licenses for software programs they often do not otherwise need or are unable to capitalize on. Presently, linear growth of web hosting networks is the industry standard. This conventional setup is also not conducive to offering third party users different operating platforms (because of constraints in growth).

### SUMMARY

A scalable non-linear network is less expensive and more efficient than a traditional linear network. Advantageously, a web host does not need to acquire licences for programs not in demand. Such a network can additionally confer a benefit of a multi-platform or multi-operating system environment for greater and more efficient growth.

In one preferred embodiment, the present invention provides a network comprised of a storage and a plurality of servers. Each server is individually in operative communication with the storage, and each server individually is operating on a pre-selected operating system. There is a plurality of encoded programs provided, with each program individually performing a single pre-selected function, and each program individually being installed and operating on its own server to the exclusion of other single pre-selected function programs.

In another preferred embodiment, the present invention provides for the building and maintaining of such a network by providing the elements previously cited, and further providing and removing on an ongoing basis any additional single pre-selected function program based on demand, the additional program being installed and operating on its own server to the exclusion of other single pre-selected function programs.

In yet another preferred embodiment, the present invention provides for the operation of such a network, for example in a web hosting environment, by providing the elements of the network, receiving a signal, directing the signal to a pre-determined server, and retrieving content from the storage.

### DESCRIPTION OF THE DRAWINGS

FIG. 1 is a perspective drawing of a network configured for multidirectional growth.

FIG. 2 is another perspective drawing of a network configured for multidirectional growth.

### DETAILED DESCRIPTION OF THE DRAWINGS

While the present invention is susceptible of embodiments in various forms, there is shown in the drawings and will hereinafter be described some exemplary and non-limiting embodiments, with an understanding that the present disclosure is to be considered an exemplification for the invention and is not intended to limit the invention to the specific embodiments illustrated. The use of a definite or indefinite article is not intended to indicate cardinality. In particular, a reference to “the” object or “a(n)” object is intended to denote also one of a possible plurality of such objects.

In a preferred embodiment of the present invention (10), a network is comprised of a storage (20) and a plurality of servers (30, 40, 50, 60). The storage (20) is conventionally a magnetic disk or other electronic re-writable media, typically housed within a computer casing. Any kind of storage media can be used provided it is of a suitable nature for storing and transmitting content, and is able to communicate with the servers (30, 40, 50, 60) in the network.

Each server (30, 40, 50, 60) is individually in operative communication with the storage (20), meaning that each server (30, 40, 50, 60) can send and receive signals from the storage (20), and in particular retrieve and receive content from the storage (20). Communication between a server (30, 40, 50, 60) and the storage (20) can occur by cable or wireless connection (not shown), depending upon preference, and such methods of communication are already known within the industry. Each server (30, 40, 50, 60) is individually a computer operating on a pre-selected operating system or platform. Operating systems provide servers with instructions for basic operability (e.g. identifying components within the computer, mapping a component's relationship to a central processor, configuring and providing access to peripheral devices, etc.). In the industry, operating systems are identified by trade-name, and are distinguished from one another by their operating features (many of which evolve over time). They do not possess generic identifying names indicative of their features, but are instead proprietary. Presently known operating systems include Windows™, Unix™, MacOS™, OS/2™, GNU™, OS/360™, OpenVMS™, Linux™, OpenBSD™, FreeBSD™, NetBSD™, and BSDi™. In a conventional network, all servers (30, 40, 50, 60) are configured with the same platform (if a second platform is desired, the web host must create a second independent network—the mixing of platforms within a single conventional network is generally not sustainable). The present invention however is not limited to one platform within a network, and does not require an additional network to provide an additional platform to third party users.

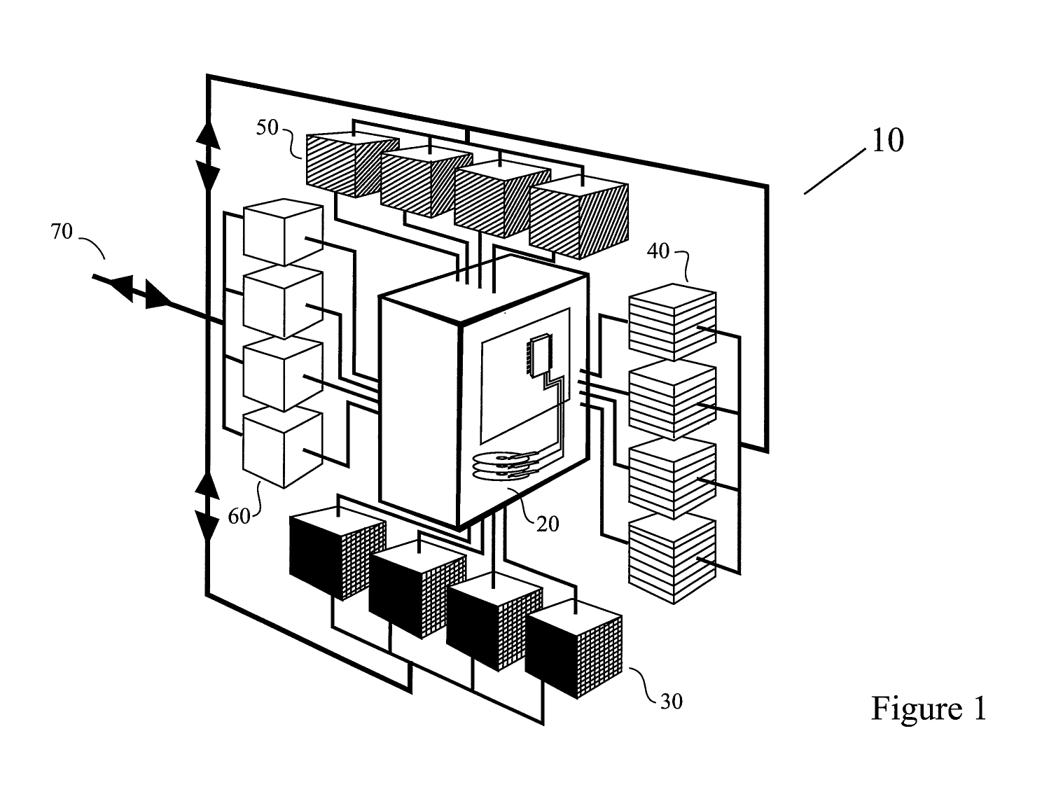

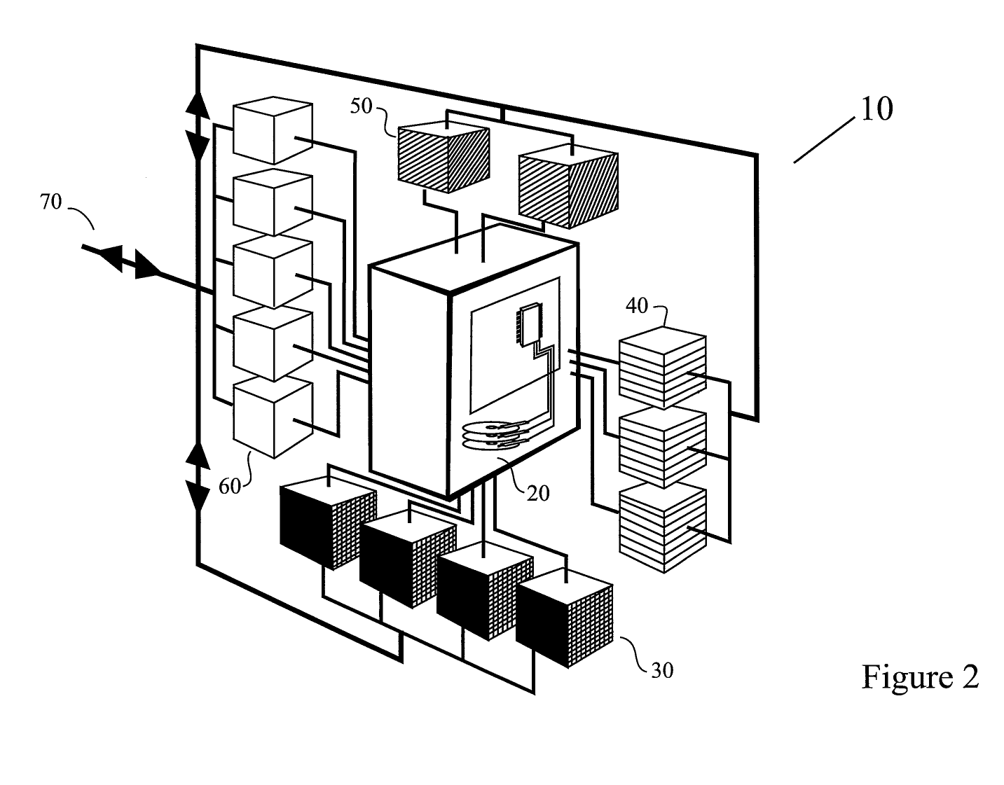

A plurality of encoded programs is provided within the network. Each program individually performs a single pre-selected function, and each program is individually installed and operates on its own server (30, 40, 50, 60) to the exclusion of other single pre-selected function programs. Referring to either FIG. 1 or FIG. 2, the different hatching shown on each of the servers (30, 40, 50, 60) represents each server being programmed with a different single pre-selected function. In an example of one embodiment, server (30) represents a server programmed to perform static content transmission and reception; server (40) represents a server programmed to perform FTP transmission and reception; server (50) represents a server programmed to perform mail transmission and reception; and server (60) represents a server programmed to perform database transmission and reception. In contrast, the prior art practice (i.e. the industry standard) is to place all of these functions on each and every server (thus forcing linear growth), such that there would be no distinction between servers (30, 40, 50 and 60).

The pre-selected function can be any one selected from a group including static content transmission, static content reception, static content transmission and reception, dynamic content transmission, dynamic content reception, dynamic content transmission and reception, FTP transmission, FTP reception, FTP transmission and reception, mail transmission, mail reception, mail transmission and reception, database transmission, database reception, database transmission and reception, content compression, content identification, content manipulation, and content filtration. Whether any particular function not stated here is further added to this list depends in part on the needs of the host's clients (i.e. this list is not exhaustive). Where any program performs both transmission and reception, this is still considered a single pre-selected function as it is not the actual transmission and/or reception that is the function per se, but rather it is the subject matter to which the program pertains that defines the function (e.g. static content, dynamic content, FTP, database, mail, etc.).

The server operating systems can all be identical or can differ from one another. The pre-selected operating system can be any one selected from a group including Windows™, Unix™, MacOS™, OS/2™, GNU™, OS/360™, OpenVMS™, Linux™, OpenBSD™, FreeBSD™, NetBSD™, and BSDi™. As operating systems evolve, more can be added to this list. The creation of additional operating systems is driven by market and proprietary need, and this list is not exhaustive. Conventional web hosting networks cannot readily offer more than one operating platform to third parties as the amount of resources required to do so are prohibitive (when the network is built according to the industry standard model). In contrast, in the present invention, because server functions are selectively and individually added, it is possible to add only a minimum number of servers operating different platforms, sufficient to meet third party need.

Because single pre-selected function programs are used (instead of group-packaged functions as currently used in the art), a network can be grown multi-directionally, more efficiently and less expensively than linear growth.

Building such a network involves providing a storage (20) and providing a plurality of dedicated servers (30, 40, 50, 60). Each server (30, 40, 50, 60) is individually configured to be in operative communication with the storage (20), in accordance with known methods of communication (e.g. cable, wireless, etc.). Each server (30, 40, 50, 60) is configured to individually operate on a pre-selected operating system (as described above), and the selection of each operating system is driven by third-party (customer) need. A plurality of encoded programs is provided, and each program individually is configured to perform a single pre-selected function, such as a function in the previously described non-exhaustive list. Each program is individually installed and operates on its own server (30, 40, 50, 60) to the exclusion of other single pre-selected function programs. Additional single pre-selected function programs are provided and removed on an ongoing basis, in accordance with customer demand. Any additional single pre-selected function program is installed and operates on its own server (30, 40, 50, 60) to the exclusion of other single pre-selected function programs.

Operating such a network, for example in a web hosting environment, entails providing the previously described network (10) and connecting the network (10) to an incoming signal source (70). In the case of the Internet™, the signal is in the form of a URL. When the signal (70) is received, it is directed to a pre-determined server (30, 40, 50, 60) according to known algorithms and rules. The server (30, 40, 50, 60) in turn communicates with the storage (20), and retrieves and receives appropriate content from the storage (20).

Specific embodiments of novel methods and apparatus for construction of a scalable web hosting network and methods for building and operating same according to the present invention have been described for the purpose of illustrating the manner in which the invention is made and used. It is understood that the implementation of other variations and modifications of the invention and its various aspects will be apparent to one skilled in the art, and that the invention is not limited by the specific embodiments described. Therefore, it is contemplated to cover the present invention including any and all modifications, variations, or equivalents that fall within the true spirit and scope of the basic underlying principles disclosed and claimed herein.

What is claimed is:

1. A network comprising:
a) a storage;
b) a plurality of servers, each server individually being in operative communication with the storage, each server individually operating on a pre-selected operating system; and
c) a plurality of encoded programs, each program individually performing a single pre-selected function, each program individually being installed and operating on its own server to the exclusion of other single pre-selected function programs.

2. The network in claim 1 wherein the pre-selected function is any one selected from a group comprising static content transmission, static content reception, static content transmission and reception, dynamic content transmission, dynamic content reception, dynamic content transmission and reception, file transfer protocol transmission, file transfer protocol reception, file transfer protocol transmission and reception, mail transmission, mail reception, mail transmission and reception, database transmission, database reception, database transmission and reception, content compression, content identification, content manipulation, and content filtration.

3. The network in claim 1 wherein the pre-selected operating system among all servers is identical.

4. The network in claim 1 wherein the pre-selected operating system among any servers differ from one another.

5. The network in claim 1 wherein the pre-selected operating system is any one selected from a group comprising Windows™ and Unix™.

6. The network in claim 1 wherein the pre-selected operating system is any one selected from a group comprising Windows™, Unix™, MacOS™, OS/2™, GNU™, OS/360™, OpenVMS™, Linux™, OpenBSD™, FreeBSD™, NetBSD™, and BSDi™.

7. The network in claim 1 for use in providing web hosting.

8. A method of operating a network comprising:
a) providing a storage;
b) providing a plurality of dedicated servers, each server individually being in operative communication with the storage, each server individually operating on a pre-selected operating system;
c) providing a plurality of encoded programs, each program individually performing a single pre-selected function, each program individually being installed and operating on its own server to the exclusion of other single pre-selected function programs;
d) receiving a signal;
e) directing the signal to a pre-determined server; and
f) retrieving content from the storage.

9. The method in claim 8 wherein the pre-selected function is any one selected from a group comprising static content transmission, static content reception, static content transmission and reception, dynamic content transmission, dynamic content reception, dynamic content transmission and reception, file transfer protocol transmission, file transfer protocol reception, file transfer protocol transmission and reception, mail transmission, mail reception, mail transmission and reception, database transmission, database reception, database transmission and reception, content compression, content identification, content manipulation, and content filtration.

10. The method in claim 8 wherein the pre-selected operating system among all servers is identical.

11. The method in claim 8 wherein the pre-selected operating system among any servers differ from one another.

12. The method in claim 8 wherein the pre-selected operating system is any one selected from a group comprising Windows™ and Unix™.

13. The method in claim 8 wherein the pre-selected operating system is any one selected from a group comprising Windows™, Unix™, MacOS™, OS/2™, GNU™, OS/360™, OpenVMS™, Linux™, OpenBSD™, FreeBSD™, NetBSD™, and BSDi™.

14. The method in claim 8 for use in providing web hosting.

15. A method of building a network comprising:
a) providing a storage;
b) providing a plurality of dedicated servers, each server individually being in operative communication with the storage, each server individually operating on a pre-selected operating system;
c) providing a plurality of encoded programs, each program individually performing a single pre-selected function, each program individually being installed and operating on its own server to the exclusion of other single pre-selected function programs; and
d) providing and removing on an ongoing basis any additional single pre-selected function program based on demand, the additional program being installed and operating on its own server to the exclusion of other single pre-selected function programs.

16. The method in claim 15 wherein the pre-selected function is any one selected from a group comprising static content transmission, static content reception, static content transmission and reception, dynamic content transmission, dynamic content reception, dynamic content transmission and reception, file transfer protocol transmission, file transfer protocol reception, file transfer protocol transmission and reception, mail transmission, mail reception, mail transmission and reception, database transmission, database reception, database transmission and reception, content compression, content identification, content manipulation, and content filtration.

17. The method in claim 15 wherein the pre-selected operating system among all servers is identical.

18. The method in claim 15 wherein the pre-selected operating system among any servers differ from one another.

19. The method in claim 15 wherein the pre-selected operating system is any one selected from a group comprising Windows™ and Unix™.

20. The method in claim 15 wherein the pre-selected operating system is any one selected from a group comprising Windows™, Unix™, MacOS™, OS/2™, GNU™, OS/360™, OpenVMS™, Linux™, OpenBSD™, FreeBSD™, NetBSD™, and BSDi™.

21. The method in claim 15 for use in providing web hosting.

22. A network comprising:
a) a storage;
b) a plurality of servers, each server individually being in operative communication with the storage, each server individually operating on a pre-selected operating system;
c) a plurality of encoded programs, each program individually performing a single pre-selected function, each program individually being installed and operating on its own server to the exclusion of other single pre-selected function programs, wherein the pre-selected function is any one selected from a group comprising static content transmission, static content reception, static content transmission and reception, dynamic content transmission, dynamic content reception, dynamic content transmission and reception, file transfer protocol transmission, file transfer protocol reception, file transfer protocol transmission and reception, mail transmission, mail reception, mail transmission and reception, database transmission, database reception, database transmission and reception, content compression, content identification, content manipulation, and content filtration.

23. A method of operating a web hosting network comprising:
a) providing a storage;
b) providing a plurality of dedicated servers, each server individually being in operative communication with the storage, each server individually operating on a pre-selected operating system;
c) providing a plurality of encoded programs, each program individually performing a single pre-selected function, each program individually being installed and operating on its own server to the exclusion of other single pre-selected function programs, wherein the pre-selected function is any one selected from a group comprising static content transmission, static content reception, static content transmission and reception, dynamic content transmission, dynamic content reception, dynamic content transmission and reception, file transfer protocol transmission, file transfer protocol reception, file transfer protocol transmission and reception, mail transmission, mail reception, mail transmission and reception, database transmission, database reception, database transmission and reception, content compression, content identification, content manipulation, and content filtration;
d) receiving a signal;
e) directing the signal to a pre-determined server; and
f) retrieving content from the storage.

24. A method of building a web hosting network comprising:
a) providing a storage;
b) providing a plurality of dedicated servers, each server individually being in operative communication with the storage, each server individually operating on a pre-selected operating system;
c) providing a plurality of encoded programs, each program individually performing a single pre-selected function, each program individually being installed and operating on its own server to the exclusion of other single pre-selected function programs, wherein the pre-selected function is any one selected from a group comprising static content transmission, static content reception, static content transmission and reception, dynamic content transmission, dynamic content reception, dynamic content transmission and reception, file transfer protocol transmission, file transfer protocol reception, file transfer protocol transmission and reception, mail transmission, mail reception, mail transmission and reception, database transmission, database reception, database transmission and reception, content compression, content identification, content manipulation, and content filtration; and
d) providing and removing on an ongoing basis any additional single pre-selected function program based on demand, the additional program being installed and operating on its own server to the exclusion of other single pre-selected function programs.
